(19) United States
(12) Patent Application Publication
(10) Pub. No.: US 2010/0118213 A1
(43) Pub. Date: May 13, 2010

(54) PROJECTION DISPLAY DEVICE

(75) Inventors: Kentaro Kato, Osaka (JP); Yoshimasa Fushimi, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/596,743

(22) PCT Filed: Apr. 21, 2008
(86) PCT No.: PCT/JP2008/001038

§ 371 Date: Oct. 20, 2009

(30) Foreign Application Priority Data
Apr. 23, 2007 (JP) 2007-112544

(51) Int. Cl. H04N 5/74; G03B 21/14; G03B 21/28

(52) U.S. Cl. 348/750; 353/97; 353/81; 348/E05.136

(57) ABSTRACT

A device includes a light source 1, a reflection-type light valve 9 that controls a traveling direction of exiting light based on an input signal, an illumination optical system 2, 3, 4, 6a that focuses light from the light source on the reflection-type light valve as illumination light, a projection lens 10 that projects exiting light from the reflection-type light valve, a first diaphragm 7 provided at a position of a pupil of the illumination optical system so as to block a part of the light from the light source, and a second diaphragm 8 provided at a position of the pupil of the projection lens so as to block a part of the exiting light from the reflection-type light valve. A part of the illumination light reflected from a surface of the reflection-type light valve to be incident on a pupil of the projection lens as unnecessary light is blocked by a combination of the first diaphragm and the second diaphragm. The light shielding region of the first diaphragm corresponds to a divided region on an outer peripheral side between divided regions obtained by dividing the region of the pupil of the illumination optical system corresponding to the range of the unnecessary light by a line in a chord direction, and a light shielding region of the second diaphragm is shaped and arranged so as to correspond to the divided region on a center side. The unnecessary light incident on the projection lens is blocked efficiently, thereby achieving high brightness performance.

### TECHNICAL FIELD

The present invention relates to a projection display device that magnifies and projects an optical image formed on a light valve onto a screen.

### BACKGROUND ART

A projection display device such as a projector is well known, which forms an optical image based on a video signal on a light valve, and illuminates the optical image with light so as to magnify and project the optical image onto a screen with a projection lens, whereby a large screen video image is obtained.

In such a projection display device, when a reflection-type light valve is used as a light valve, both a high resolution and a high pixel aperture ratio can be achieved, whereby it becomes possible to display a high-brightness projected image with high light utilization efficiency.

FIG. 4 shows a configuration of an optical system in a conventional projection display device using a reflection-type light valve as described above. Such a configuration is disclosed in Patent Document 1, for example.

In FIG. 4, light emitted from a lamp 1 as a light source is focused on a reflection-type light valve 9 via a total reflection prism 6a by an illumination optical system including a concave mirror 2, a rod prism 3, and a condenser lens 4. The rod prism 3 has a quadratic prism shape in cross section, and has substantially the same aspect ratio as that of an effective display area of the reflection-type light valve 9. A color wheel 5 is provided between the concave mirror 2 and the rod prism 3. The light reflected from the reflection-type light valve 9 passes through a dichroic prism 6b as a color separator and combiner optical system to be projected onto a screen (not shown) by a projection lens 10.

The concave mirror 2, in which a cross-sectional shape of a reflection surface forms an ellipse, has a first focal point and a second focal point. The concave mirror 2 is arranged so that a center of an illuminant of the lamp 1 is located in the vicinity of the first focal point of the concave mirror 2 and a light incident surface of the rod prism 3 is located in the vicinity of the second focal point. The concave mirror 2 is formed of a member obtained by forming an optical multilayer film that allows infrared light to pass therethrough and reflects visible light on an inner surface of a glass material.

The light emitted from the lamp 1 is reflected and condensed by the concave mirror 2, so that an illuminant image of the lamp 1 is formed at the second focal point of the concave mirror 2. There is a tendency for the illuminant image of the lamp 1 to be brightest in a central region dose to an optical axis and become dark rapidly toward the circumference, so that the brightness is non-uniform.

To avoid this problem, the incident surface of the rod prism 3 is arranged in the vicinity of the second focal point, so that the incident light is subjected to multiple reflection on a side surface of the rod prism 3, thereby making the brightness uniform. In this manner, by forming a secondary surface light source at an exiting surface of the rod prism 3, and forming an image on the reflection-type light valve 9 with the downstream condenser lens 4, uniform illumination light can be secured.

The color wheel 5 is composed of a combination of three color filters, each allowing only one of light beams of three primary colors to pass therethrough. By the color wheel 5 arranged in the vicinity of the second focal point of the concave mirror 2, the white light output from the lamp 1 is time-divided into light beams of three primary colors of red, green, and blue. More specifically, by rotating the color wheel 5, the light beams of three primary colors of red, green, and blue sequentially illuminate the reflection-type light valve 9 in a time-division manner. Thus, a full-color projected image can be displayed by using the one display element (reflection-type light valve 9).

A diaphragm 11 is provided at a position of a pupil of the illumination optical system so as to eliminate unnecessary light to be described later. The diaphragm 11 is arranged such that the center of gravity of an aperture is eccentric with respect to the optical axis of the illumination optical system, for the purpose of achieving higher contrast performance while minimizing brightness degradation by suppressing the blocking of necessary light.

Next, a configuration and an operation of the reflection-type light valve 9 will be described with reference to FIGS. 5A to 5C. In general, the reflection-type light valve 9 controls a traveling direction of light based on a video signal so as to form an optical image as a change in reflection angle. FIGS. 5A to 5C are cross-sectional views for explaining the configuration and the operation of the reflection-type light valve in the conventional projection display device.

This reflection-type light valve 9, which is called a DMD (Digital Micro-mirror Device), has mirror elements 12 formed in a matrix on a pixel basis. An inclination angle of each of the mirror elements 12 with respect to a reference plane 13 perpendicular to an optical axis of the projection lens 10 (see FIG. 4) is controlled based on an ON signal for a white image and an OFF signal for a black image. An illumination principal ray 15 passes through a cover glass 14, is incident on and reflected from the mirror elements 12, and passes through the cover glass 14 again to exit.

At the time of the ON signal, as shown in FIG. 5A, the mirror elements 12 are controlled so as to form an angle of +θ° with respect to the reference plane 13. At this time, an incident angle of the illumination principal ray 15 is set so that an ON-light principal ray 16 is reflected in a direction perpendicular to the reference plane 13, i.e., a direction along the optical axis of the projection lens 10. Accordingly, an angle formed between the illumination principal ray 15 and the ON-light principal ray 16 is 2θ.

At the time of the OFF signal, as shown in FIG. 5B, the mirror elements 12 are controlled so as to form an angle of −θ° with respect to the reference plane 13. At this time, an angle formed between the illumination principal ray 15 and an OFF-light principal ray 17 is 6θ. As a result, the OFF-light principal ray 17 is reflected and travels in a direction in which it is not incident on the projection lens 10.

Further, as shown in FIG. 5C, the illumination light is reflected from a surface of the cover glass 14 as flat light 18. Regardless of whether it is the time of the ON signal or the OFF signal, an angle formed between the illumination principal ray 15 and a principal ray of the flat light 18 is 4θ. At either of the times of the ON signal and the OFF signal, the flat light 18 is partially incident on the projection lens 10, which results in a problem that the flat light 18 causes significant contrast performance degradation, particularly at the time of the OFF signal for a black image.

Next, a description will be given of the reason why the flat light 18 causes contrast degradation, with reference to FIG. 6 for explaining the incidence and reflection in the illumination optical system. In FIG. 6, among the light beams incident on the reflection-type light valve 9, a light beam that is inclined most with respect to the optical axis of the illumination light forms an illuminating angle θa. In other words, the illumination light is incident on the reflection-type light valve 9 within a range of the illuminating angle θa with the illumination principal ray 15 as a center. Reference numeral 19 denotes the pupil of the illumination optical system, and reference numeral 20 denotes a pupil of the projection lens 10. Reference numeral 21 denotes a spot of the flat light 18 at a position corresponding to the pupil 20 of the projection lens 10.

The ON-light principal ray 16 reflected from the reflection-type light valve 9 in a direction forming an angle of 2θ with respect to the illumination principal ray 15 is incident on the projection lens 10 through the pupil 20 to be projected onto a screen. On the other hand, the flat light 18 is reflected from the reflection-type light valve 9 in a direction forming an angle of 4θ with respect to the illumination principal ray 15.

Here, when the illuminating angle θa is not less than θ, the flat light 18 is partially incident on the projection lens 10 as unnecessary light 22. An overlapping range between the pupil 20 of the projection lens 10 and the spot 21 of the flat light 18 corresponds to the unnecessary light 22. The unnecessary light 22 causes significant contrast performance degradation, particularly at the time of the OFF signal.

In general, in the projection video device with the reflection-type light valve, the illuminating angle θa is larger than θ since an illumination F value of the illumination optical system is set to be small so as to achieve high light utilization efficiency.

In order to eliminate the unnecessary light 22, the diaphragm 11 is provided at the position of the pupil of the illumination optical system as shown in FIG. 4. As shown in FIG. 6, a light shielding region 23 of the diaphragm 11 in the pupil 19 of the illumination optical system is set so as to correspond to the region of the unnecessary light 22 in the spot 21 of the flat light 18 reflected from the reflection-type light valve 9.

The light shielding region 23 of the diaphragm 11 has a shape corresponding to that of the region of the unnecessary light 22. The region of the unnecessary light 22 is a range in which the spot 21 of the flat light 18 overlaps the pupil 20 of the projection lens 10, i.e., an overlapping region between the two circles. Thus, as shown in FIG. 7, the light shielding region 23 has a biconvex lens shape surrounded by two arcs having the same curvature as that of a periphery of the pupil 19 of the illumination optical system. In the following description, this shape will be merely referred to as a “lens shape”.

The light shielding region 23 in the pupil 19 is arranged structurally as follows. That is, the light shielding region 23 is arranged such that one of the arcs of the lens shape follows the periphery of the region of the pupil 19. The symmetry axis of the lens shape is directed toward a direction of an intersection line of a plane including the illumination principal ray 15 and the ON-light principal ray 16 with a plane of the pupil 19. And, the light shielding region 23 is arranged on one end side of the diameter of the pupil 19 closer to the ON-light principal ray 16 at a position where the light is just before being incident on the reflection-type light valve 9.

The light shielding region 23 can prevent the unnecessary light 22 from being incident on the pupil 20 of the projection lens 10. More specifically, among the illumination light having the illuminating angle θa with the illumination principal ray 15 as a center, light that will become the unnecessary light 22 is prevented from being incident on the reflection-type light valve 9 by the light shielding region 23 of the diaphragm 11.

### Patent Document 1: JP 2004-94262 A

### DISCLOSURE OF INVENTION

### Problem to be Solved by the Invention

The brightness distribution in a pupil is such that it is brightest in a central region close to the optical axis and becomes dark rapidly toward the circumference. Thus, as shown in FIG. 7 for explaining a light shielding state, the light shielding region 23 of the diaphragm 11 having the above-described lens shape blocks a luminous flux in the vicinity of the optical axis having high brightness, which thus results in a large brightness loss.

In order to solve the above-described problem, it is an object of the present invention to provide a projection display device that efficiently eliminates unnecessary light of flat light incident on a projection lens by optimizing the shape of a diaphragm, thereby achieving high brightness performance.

### Means for Solving Problem

A projection display device according to the present invention includes: a light source; a reflection-type light valve that controls a relationship of a traveling direction of exiting light with respect to incident light based on an input signal; an illumination optical system that focuses light from the light source on the reflection-type light valve as illumination light; a projection lens that projects exiting light from the reflection-type light valve; and a first diaphragm provided at a position of a pupil of the illumination optical system so as to block a part of the light from the light source. The first diaphragm forms a light shielding region for a part of a region of the pupil of the illumination optical system that corresponds to a range in which light, among the illumination light, reflected from a surface of the reflection-type light valve is incident on a pupil of the projection lens as unnecessary light.

In order to solve the above-described problem, the projection display device according to the present invention further includes a second diaphragm provided at a position of the pupil of the projection lens so as to block a part of the exiting light from the reflection-type light valve. The light shielding region of the first diaphragm corresponds to a divided region on an outer peripheral side between two divided regions obtained by dividing the region of the pupil of the illumination optical system corresponding to the range of the unnecessary light by a line in a chord direction. The second diaphragm forms a light shielding region that has a shape corresponding to the divided region on a center side and is arranged at a position corresponding to the divided region on the center side.

### EFFECTS OF THE INVENTION

With this configuration, it is possible to reduce a loss of the illumination light caused by the first diaphragm, while securing the light shielding property for the unnecessary light, thereby suppressing a decrease in contrast. Thus, it is possible to achieve higher brightness in a projection display device such as a projector.

### BRIEF DESCRIPTION OF DRAWINGS

FIG. 1 is a view showing a configuration of an optical system of a projection display device according to an embodiment of the present invention.

FIG. 2 is a view showing a state of light incidence and reflection in an illumination optical system of the same projection display device.

FIG. 3A is a view showing light shielding states in pupils of an illumination optical system and a projection lens due to a diaphragm of a conventional projection display device.

FIG. 3B is a view showing an example of light shielding states in pupils of the illumination optical system and a projection lens due to diaphragms of the projection display device according to the embodiment of the present invention.

FIG. 3C is a view showing another example of light shielding states in the pupils of the illumination optical system and the projection lens due to the diaphragms of the same projection display device.

FIG. 4 is a view showing a configuration of an optical system of a conventional projection display device.

FIG. 5A is a view showing a configuration and an operation of a reflection-type light valve in the same projection display device.

FIG. 5B is a view showing another operation of the reflection-type light valve in the same projection display device.

FIG. 5C is a view showing still another operation of the reflection-type light valve in the same projection display device.

FIG. 6 is a view showing a state of light incidence and reflection in the illumination optical system of the same projection display device.

FIG. 7 is a view showing a light shielding state due to the diaphragm of the same projection display device.

### EXPLANATION OF LETTERS OR NUMERALS

1 Lamp
2 Concave mirror
3 Rod prism
4 Condenser lens
5 Color wheel
6a Total reflection prism
6b Dichroic prism
7 First diaphragm
8 Second diaphragm
9 Reflection-type light valve
10 Projection lens
11 Diaphragm
12 Mirror element
13 Reference plane
14 Cover glass
15 Illumination principal ray
16 ON-light principal ray
17 OFF-light principal ray
18 Flat light
19 Pupil of illumination optical system
20 Pupil of projection lens
21 Spot of flat light
22 Unnecessary light
23 Light shielding region
24, 24a, 24b Light shielding region
25, 25a, 25b Light shielding region

### DESCRIPTION OF THE INVENTION

Based on the above-described configuration, the projection display device of the present invention may have the following aspects.

More specifically, preferably, the reflection-type-light valve is formed of a plurality of mirror elements arranged in a matrix, each controlling a reflection direction of light based on a video signal.

Further, preferably, the light shielding region of the first diaphragm has a shape equivalent to that of one of the divided regions obtained by dividing a convex lens shape surrounded by two arcs by a straight line parallel to a line connecting both apexes of the lens shape, and the light shielding region of the second diaphragm has a shape equivalent to that of the other divided region.

Further, preferably, on an incident side surface of each of the first diaphragm and the second diaphragm, a reflection mirror formed of a metal or a dielectric multiplayer film is formed so as to reflect at least 80% or more of incident light.

Further, preferably, the illumination optical system has a rod prism whose length is set so that circumferential illumination is 90% or more with respect to central illumination.

Hereinafter, an embodiment of the present invention will be described with reference to the drawings.

### Embodiment

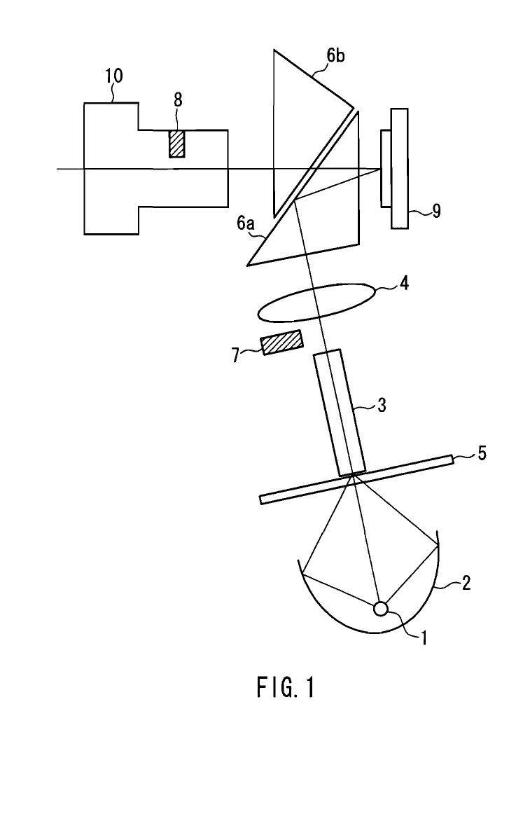

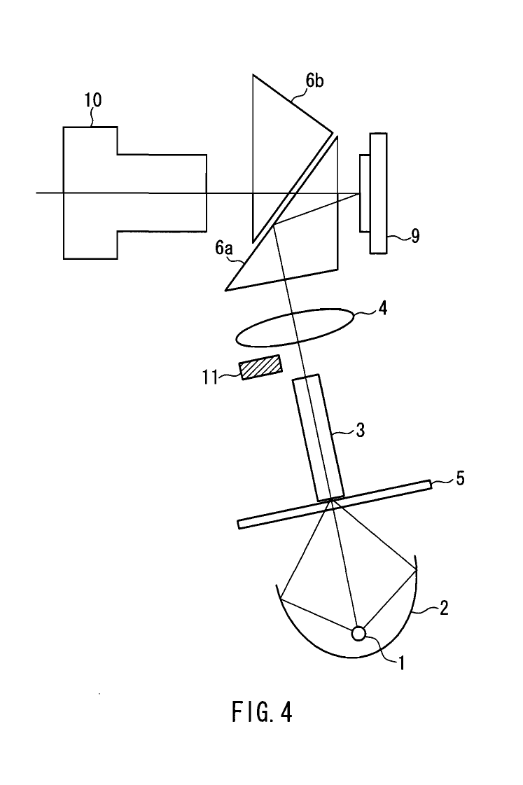

FIG. 1 is a view showing a configuration of an optical system of a projection display device according to an embodiment of the present invention. In FIG. 1, a lamp 1 as a light source, a concave mirror 2, a rod prism 3, a condenser lens 4, a color wheel 5, a dichroic prism 6, a reflection-type light valve 9, and a projection lens 10 have the same configurations as those in the conventional example shown in FIG. 4.

In the present embodiment, instead of the diaphragm 11 in the conventional example shown in FIG. 4, a first diaphragm 7 provided at a position of a pupil of an illumination optical system and a second diaphragm 8 provided at a position of a pupil of the projection lens 10 are used in combination so as to function to block flat light. The configurations of the first diaphragm 7 and the second diaphragm 8 will be described later.

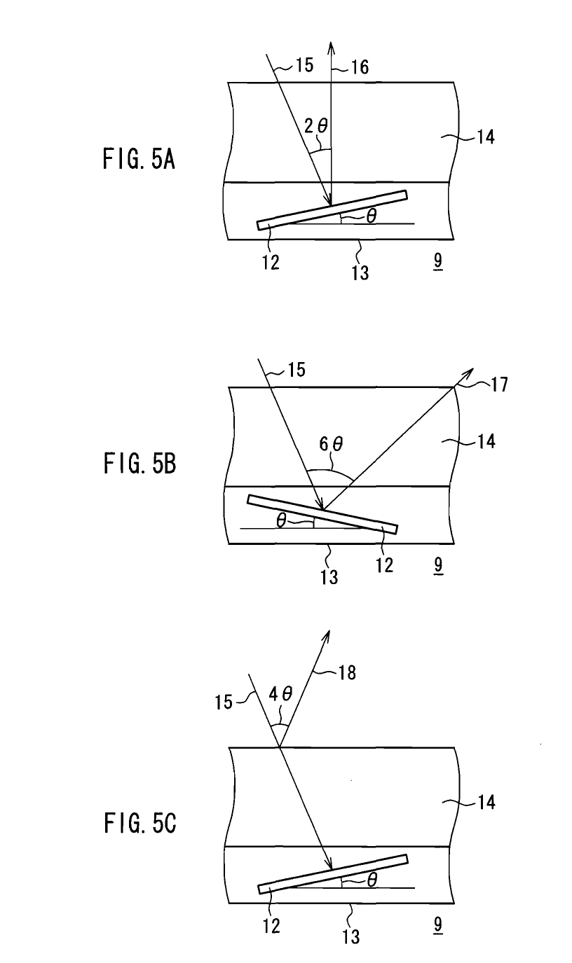

As in the conventional example shown in FIG. 5, the reflection-type light valve 9 has mirror elements 12 formed in a matrix on a pixel basis, and controls a traveling direction of light based on a video signal so as to form an optical image in accordance with a change in reflection angle.

Further, the concave mirror 2 is formed of an ellipsoidal mirror in which a cross-sectional shape of a reflection surface forms an ellipse, and has a first focal point and a second focal point. The lamp 1 may be a high-pressure mercury lamp, and is arranged so that a center of an illuminant is located in the vicinity of the first focal point of the concave mirror 2. The rod prism 3 is arranged so that its light incident surface is located in the vicinity of the second focal point of the concave mirror 2.

The rod prism 3 has a quadratic prism shape in which a light incident surface and a light exiting surface have the same aspect ratio as that of an effective display area of the reflection-type light valve 9. The rod prism 3 is provided at a place where light emitted from the lamp 1 is condensed, so that it preferably is made of quartz glass having excellent heat resistance.

An illuminant image of the lamp 1 condensed by the concave mirror 2 is formed in the vicinity of the incident surface of the rod prism 3. There is a tendency for the illuminant image of the lamp 1 condensed by the concave mirror 2 to be brightest in a central region close to the optical axis and become dark rapidly toward the circumference, so that the brightness is non-uniform on the surface. In contrast, a luminous flux incident on the rod prism 3 is subjected to multiple reflection on a side surface of the rod prism 3, and the illuminant image is divided minutely and overlapped by the number of reflections to be illuminated, so that the brightness is made uniform on the exiting surface of the rod prism 3.

Thus, due to the effect of minute division and overlapping of the illuminant image of the lamp, as the number of reflections in the rod prism 3 is larger, uniformity is enhanced. Therefore, the degree of uniformity depends on the length of the rod prism 3. In the present embodiment, the length of the rod prism 3 is set so that the circumferential illumination on a screen is 90% or more with respect to the central illumination.

As described above, the exiting surface of the rod prism 3, in which brightness is made uniform, is set as a secondary surface light source, and an image is formed with the condenser lens 4 provided downstream at a magnification that is matched with an effective display area of the reflection-type light valve 9. Consequently, both the securing of a condensing efficiency and the enhancement of uniformity can be satisfied.

Further, by rotating the color wheel 5 arranged in the vicinity of the second focal point of the concave mirror 2, the white light output from the lamp 1 is divided into light beams of three primary colors of red, green, and blue, which pass sequentially so as to illuminate the reflection-type light valve 9 in a time-division manner. Thus, a full-color projected image can be displayed by using the one reflection-type light valve 9.

Further, as in the conventional example shown in FIGS. 5A to 5C, the light emitted from the lamp 1 and condensed by the illumination optical system is incident on the reflection-type light valve 9. As shown in FIG. 5A, among the illumination principal rays 15 incident on the reflection-type light valve 9, the ON-light principal ray 16 reflected for a white image is incident on the projection lens 10 to be magnified and projected onto a screen (not shown). On the other hand, as shown in FIG. 5B, the OFF-light principal ray 17 for a black image travels outside of an effective diameter of the projection lens 10, and does not reach the screen.

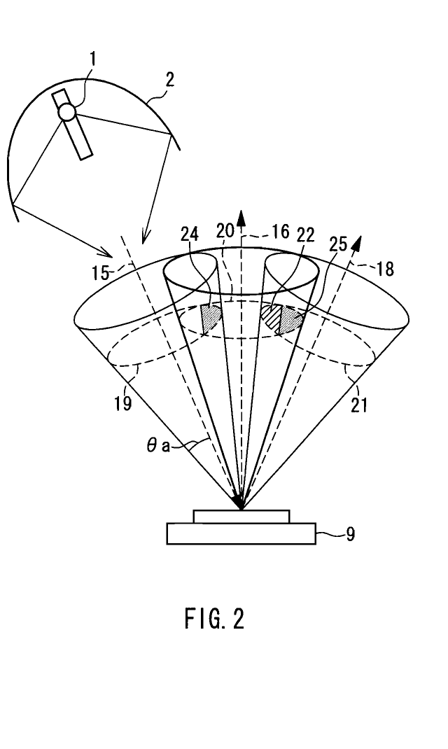

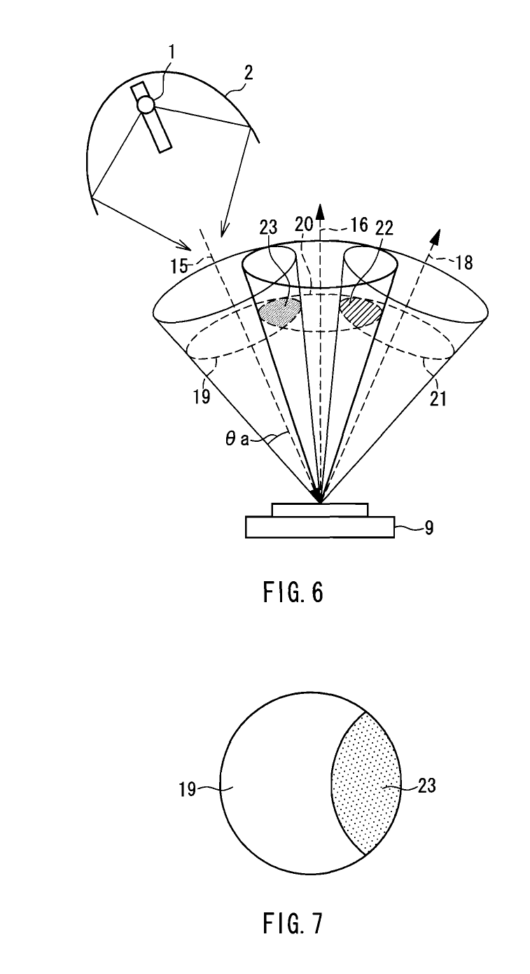

Next, with reference to FIG. 2 for explaining the incidence and reflection in the illumination optical system, a description will be given of the relationship between the shapes of the first diaphragm 7 provided at the position of the pupil 19 of the illumination optical system as well as the second diaphragm 8 provided at the position of the pupil 20 of the projection lens 10 and the blocking of the unnecessary light 22. In FIG. 2, the relationship between the incidence and reflection of the illumination principal ray 15 on/from the reflection-type light valve 9 is the same as that in the conventional example shown in FIG. 6, and thus the same components are denoted with the same reference numerals and descriptions thereof will not be repeated.

Alight shielding region 24 of the first diaphragm 7 is positioned similarly but shaped differently to/from that of the diaphragm 11 in the conventional example shown in FIG. 6. More specifically, the shape of the light shielding region 24 is equivalent to that of a region on an outer peripheral side obtained when the lens shape of the conventional light shielding region is divided by a line in a direction along a chord of an outer shape of the pupil 19, i.e., a line parallel to a line connecting both apexes of the lens shape. In other words, the shape of the light shielding region 24 is equivalent to that obtained when a region on a center side is deleted from the lens shape of the diaphragm 11 in the conventional example.

On the other hand, a light shielding region 25 of the second diaphragm 8 has a shape corresponding to a remaining portion obtained when the light shielding region 24 of the first diaphragm 7 is cut from the conventional light shielding region with the lens shape. The light shielding region 25 is arranged on an outer peripheral side of a region corresponding to the unnecessary light 22 in the pupil 20 of the projection lens 10. The light shielding region 24 of the first diaphragm 7 corresponds to a region on an outer peripheral side of the region of the unnecessary light 22 in the flat light 18, and accordingly is located on a center side in the pupil 20. Thus, similarly to the conventional diaphragm 11, a combined light shielding region of the light shielding region 24 of the first diaphragm 7 and the light shielding region 25 of the second diaphragm 8 corresponds to the entire region of the unnecessary light 22.

However, the light shielding region 24 of the first diaphragm 7 and the light shielding region 25 of the second diaphragm 8 do not necessarily need to cover the region of the unnecessary light 22 completely. Even if the light shielding region is somewhat inadequate for the region of the unnecessary light 22, a practically sufficient effect can be achieved.

As described above, the combined light shielding region of the first diaphragm 7 and the second diaphragm 8 blocks the same amount of unnecessary light 22 as that blocked by the light shielding region of the diaphragm 11 provided in the conventional illumination optical system. However, in each of the pupil 19 of the illumination optical system and the pupil 20 of the projection lens 10, a luminous flux is stopped in the area divided from the periphery. Thus, light in the central region of the luminous flux having high brightness can be included in the ON light without being blocked, and further the unnecessary light 22 of the flat light 18 can be blocked. Consequently, a brightness loss is reduced with equal contrast performance, resulting in higher brightness than that in the conventional example.

As described above, the light shielding region 24 of the first diaphragm 7 and the light shielding region 25 of the second diaphragm 8 are arranged so that their respective symmetry axes coincide with planes including the illumination principal ray 15 and the ON-light principal ray 16. The light shielding region 25 of the second diaphragm 8 is arranged on one end side of the diameter of the pupil 20 closer to the flat light 18.

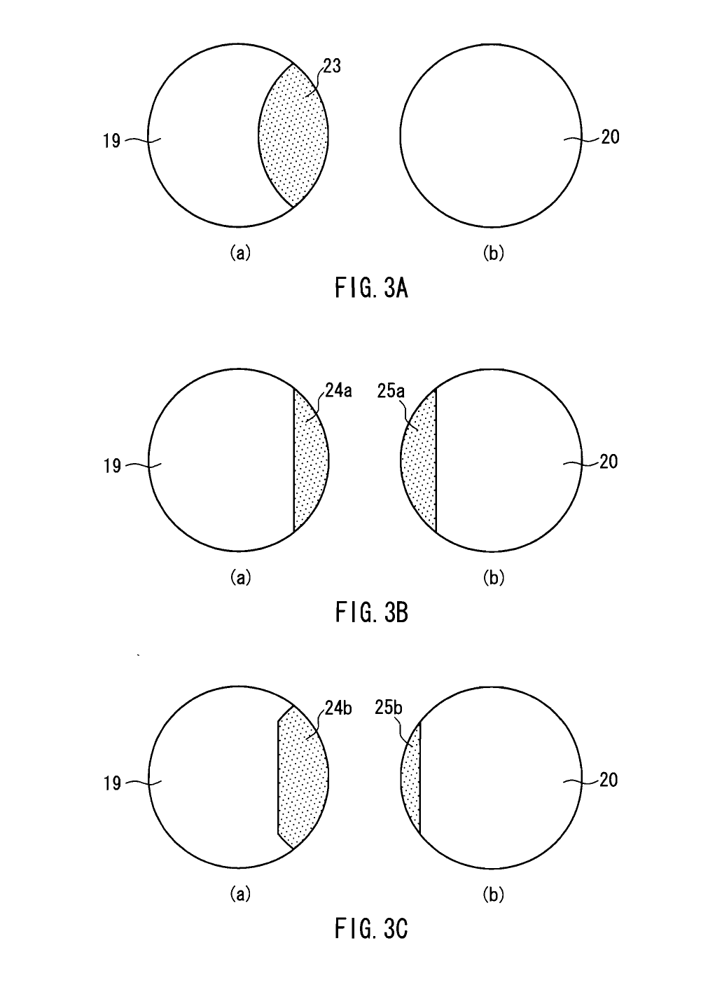

Next, configurations of the first diaphragm 7 and the second diaphragm 8 will be described with reference to FIGS. 3A to 3C for explaining light shielding states. FIG. 3A shows a light shielding state when the diaphragm is provided only at the position of the pupil of the illumination optical system, which is the same as that in the conventional example shown in FIG. 7. It is understood that no diaphragm is provided at the position of the pupil of the projection lens. FIGS. 3B and 3C show light shielding states of the present embodiment.

In FIG. 3A, (a) shows the light shielding region 23 of the diaphragm 11 in the pupil 19 of the illumination optical system in the conventional example. In FIGS. 3B and 3C, (a) shows light shielding regions 24a and 24b of the first diaphragm 7 in the pupil 19 of the illumination optical system in the present embodiment. In FIG. 3A, (b) shows the pupil 20 of the projection lens 10, in which no light shielding region is provided in this case. In FIGS. 3B and 3C, (b) shows light shielding regions 25a and 25b of the second diaphragm 8 in the pupil 20 of the projection lens 10.

The light shielding region of the first diaphragm 7 has a shape equivalent to that of one region obtained when the lens shape is divided by a straight line parallel to a line connecting both apexes of the lens shape. More specifically, the arcuate light shielding region 24a surrounded by a chord and an arc of the circle as shown in (a) in FIG. 3B, or the light shielding region 24b having a shape obtained when an actuate portion is cut from the lens shape as shown in (a) in FIG. 3C is used. A region on a center side of the pupil 19 is deleted, and a divided region on an outer peripheral side is used.

The second diaphragm 8 forms the light shielding region 25a or 25b having a shape corresponding to a remaining portion obtained when the light shielding region of the first diaphragm 7 is cut from the lens shape. Namely, the conventional light shielding region 23 shown in FIG. 3A is divided by the first diaphragm 7 and the second diaphragm 8, so that the light shielding regions 24a and 25a or the light shielding regions 24b and 25b are used in combination as shown in FIG. 3B or 3C.

The light shielding regions 24b and 25b in FIG. 3C are different from the light shielding regions 24a and 25a in FIG. 3B in that a smaller weight is assigned to the second diaphragm 8 with respect to the light shielding ratio of a luminous flux. In either case, the sum of a light shielding area of the first diaphragm 7 and a light shielding area of the second diaphragm 8 desirably is the same as a light shielding area of the diaphragm 11 provided in the conventional illumination optical system.

By dividing the light shielding region in this manner, light in the central region of the luminous flux having high brightness is not blocked, while peripheral light is blocked, resulting in a smaller brightness loss and higher brightness than in the conventional example.

In general, when a diaphragm is provided for a projection lens, the diaphragm absorbs light to cause thermal expansion and contraction of a lens mirror and the like, which may result in deterioration of focusing performance. In such a case, a diaphragm amount of the projection lens may be determined so as not to cause a problem in projection lens performance.

Further, it is desirable that a reflective film made of a metal or a dielectric multilayer film is formed on surfaces of the diaphragm of the illumination optical system and the diaphragm of the projection lens so as to reflect 80% or more of incident light.

### INDUSTRIAL APPLICABILITY

The projection display device of the present invention can reduce a light loss caused by the diaphragm for blocking unnecessary light, thereby suppressing a decrease in contrast. Therefore, the present invention is useful as a projection display device such as a projector.

1. A projection display device comprising:
a light source;
a reflection-type light valve that controls a relationship of a traveling direction of exiting light with respect to incident light based on an input signal;
an illumination optical system that focuses light from the light source on the reflection-type light valve as illumination light;
a projection lens that projects exiting light from the reflection-type light valve; and
a first diaphragm provided at a position of a pupil of the illumination optical system so as to block a part of the light from the light source,
wherein the first diaphragm forms a light shielding region for a part of a region of the pupil of the illumination optical system that corresponds to a range in which light, among the illumination light, reflected from a surface of the reflection-type light valve is incident on a pupil of the projection lens as unnecessary light,
the device further comprising a second diaphragm provided at a position of the pupil of the projection lens so as to block a part of the exiting light from the reflection-type light valve,
wherein the light shielding region of the first diaphragm corresponds to a divided region on an outer peripheral side between two divided regions obtained by dividing the region of the pupil of the illumination optical system corresponding to the range of the unnecessary light by a line in a chord direction, and
the second diaphragm forms a light shielding region that has a shape corresponding to the divided region on a center side and is arranged at a position corresponding to the divided region on the center side.

2. The projection display device according to claim 1, wherein the reflection-type light valve is formed of a plurality of mirror elements arranged in a matrix, each controlling a reflection direction of light based on a video signal.

3. The projection display device according to claim 1, wherein the light shielding region of the first diaphragm has a shape equivalent to that of one of the divided regions obtained by dividing a convex lens shape surrounded by two arcs by a straight line parallel to a line connecting both apexes of the lens shape, and the light shielding region of the second diaphragm has a shape equivalent to that of the other divided region.

4. The projection display device according to claim 1, wherein on an incident side surface of each of the first diaphragm and the second diaphragm on, a reflection mirror formed of a metal or a dielectric multiplayer film is formed so as to reflect at least 80% or more of incident light.

5. The projection display device according to claim 1, wherein the illumination optical system has a rod prism whose length is set so that circumferential illumination is 90% or more with respect to central illumination.
